(19) United States
(12) Patent Application Publication
(10) Pub. No.: US 2026/0185563 A1
(43) Pub. Date: Jul. 2, 2026

(54) BEARING UNIT AND GEARING

(71) Applicant: Mitsubishi Electric Corporation, Chiyoda-ku,Tokyo (JP)

(72) Inventors: Michinori HASHIMOTO, Chiyoda-ku, Tokyo (JP); Kota NAKAFUJI, Chiyoda-ku, Tokyo (JP)

(73) Assignee: Mitsubishi Electric Corporation, Chiyoda-ku, Tokyo (JP)

(21) Appl. No.: 18/859,343

(22) PCT Filed: Apr. 28, 2022
(86) PCT No.: PCT/JP2022/019245

§ 371 Date: Oct. 23, 2024

(51) Int. Cl. F16C 19/38; F16C 33/66

(52) U.S. Cl. CPC F16C 33/6685; F16C 33/80; F16C 2326/10; F16C 2361/61

(57) ABSTRACT

A bearing unit includes a first bearing, a first bearing retainer, and an oil thrower. The first bearing supports a shaft such that the shaft is rotatable. The first bearing retainer retains the first bearing while the shaft is disposed through a through hole of the first bearing retainer. The oil thrower is attached to the shaft at a position between the first bearing retainer and the first bearing, and extends toward the first bearing retainer and defines a labyrinth structure against the first bearing retainer. The oil thrower has grooves circumferentially arranged on the outer periphery.

### TECHNICAL FIELD

The present disclosure relates to a bearing unit and a gear mechanism.

### BACKGROUND ART

Railway vehicles include gear mechanisms that transfer rotational force from motors to axles. A typical example of this type of gear mechanism is disclosed in Patent Literature 1. The gear mechanism disclosed in Patent Literature 1 includes a small gear attached to a driving shaft coupled to a motor, and a large gear coupled to an axle such that the large gear meshes with the small gear. The gear mechanism further includes a shaft bearing that supports the driving shaft such that the driving shaft is rotatable, an axle bearing that supports the axle such that the axle is rotatable, and a gear housing that accommodates the small gear, the large gear, the shaft bearing, and the axle bearing while the shaft and the axle are disposed through the gear housing. The gear housing also accommodates a lubricant enclosed therein.

To suppress leakage of the lubricant from the gear housing, the driving shaft is provided with an oil thrower that defines a labyrinth structure against a shaft bearing retainer for retaining the shaft bearing, and the axle is provided with another oil thrower that defines a labyrinth structure against an axle bearing retainer for retaining the axle bearing.

### CITATION LIST

### Patent Literature

Patent Literature 1: Unexamined Japanese Patent Application Publication No. 2017-009085

### SUMMARY OF INVENTION

### Technical Problem

The small gear is attached to the driving shaft, which is coupled to the output shaft of the motor via a joint. For example, the driving shaft is coupled to the output shaft of the motor via a Cardan joint including flexible plates. In this structure, the rotation of the flexible plates during rotation of the output shaft generates radially outward airflows. The airflows induce negative pressures around the output shaft and the driving shaft outside the gear housing. Such a negative pressure around the driving shaft outside the gear housing generates outward airflows from the inside of the gear housing along the driving shaft. These airflows unintentionally facilitate the lubricant to exit the gear housing through the portion of the gear housing that receives the driving shaft.

Such leakage and reduction of the lubricant inside the gear housing may lead to wear of the small gear, the large gear, the shaft bearing, and the axle bearing.

An objective of the present disclosure, which has been accomplished in view of the above situations, is to provide a bearing unit that is included in a gear mechanism and suppresses leakage of a lubricant, and a gear mechanism to suppress leakage of a lubricant.

### Solution to Problem

In order to achieve the above objective, a bearing unit according to the present disclosure includes a first bearing, a first bearing retainer, and an oil thrower. The first bearing supports a shaft such that the shaft is rotatable. The first bearing retainer has a through hole that receives the shaft inserted therethrough, and retains the first bearing while the shaft is disposed through the through hole. The oil thrower is attached to the shaft at a position between the first bearing retainer and the first bearing, and extends toward the first bearing retainer and defines a labyrinth structure against the first bearing retainer. The oil thrower has grooves circumferentially arranged on the outer periphery.

### Advantageous Effects of Invention

The bearing unit according to the present disclosure includes the oil thrower that defines a labyrinth structure against the first bearing retainer and has grooves circumferentially arranged on the outer periphery. The bearing unit, when installed in a gear mechanism, can thus suppress leakage of a lubricant enclosed in a gear housing.

### BRIEF DESCRIPTION OF DRAWINGS

FIG. 1 is a top view of a bogie provided with gear mechanisms according to Embodiment 1;

FIG. 2 is a sectional view of the gear mechanism according to Embodiment 1 taken along the line II-II of FIG. 1;

FIG. 3 is a sectional view of the gear mechanism according to Embodiment 1 taken along the line III-III of FIG. 2;

FIG. 4 is a partial sectional view of the gear mechanism according to Embodiment 1;

FIG. 5 is another partial sectional view of the gear mechanism according to Embodiment 1;

FIG. 6 is a perspective view of an oil thrower according to Embodiment 1;

FIG. 7 is a partially enlarged view of the oil thrower according to Embodiment 1;

FIG. 8 illustrates an example of flows of a lubricant in the gear mechanism according to Embodiment 1;

FIG. 9 is a sectional view of a gear mechanism according to Embodiment 2 taken along the line IX-IX of FIG. 2;

FIG. 10 is a partial sectional view of the gear mechanism according to Embodiment 2;

FIG. 11 is another partial sectional view of the gear mechanism according to Embodiment 2;

FIG. 12 is another partial sectional view of the gear mechanism according to Embodiment 2;

FIG. 13 illustrates an example of flows of a lubricant in the gear mechanism according to Embodiment 2;

FIG. 14 illustrates another example of flows of a lubricant in the gear mechanism according to Embodiment 2;

FIG. 15 is a partial sectional view of a modification of the gear mechanism according to the embodiments; and

FIG. 16 is a partially enlarged view of a modification of the oil thrower according to the embodiments.

### DESCRIPTION OF EMBODIMENTS

A bearing unit and a gear mechanism according to embodiments of the present disclosure are described in detail below with reference to the accompanying drawings. In the drawings, the components identical or corresponding to each other are provided with the same reference symbol.

### Embodiment 1

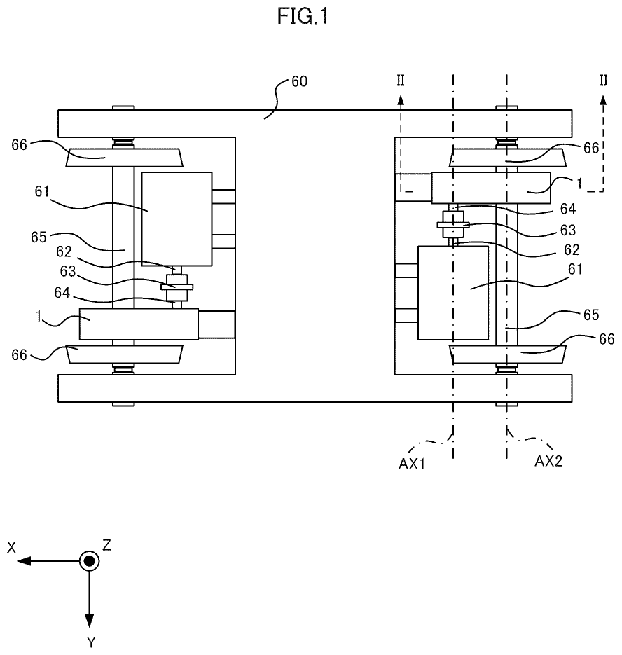

The following describes a gear mechanism 1 according to Embodiment 1 focusing on an exemplary gear mechanism to be installed in a railway vehicle. As illustrated in FIG. 1, a bogie 60 of the railway vehicle is provided with gear mechanisms 1. The bogie 60 is also provided with motors 61 that rotate by receiving electric power from a power supply, which is not illustrated. Each of the motors 61 has an output shaft 62, which transfers rotational force via a joint 63 to a driving shaft 64. The rotational force transferred from the motor 61 via the joint 63 is transferred by the gear mechanism 1 to an axle 65 serving as a driven shaft. The axle 65 is provided with wheels 66 at both ends.

In FIG. 1, the X axis represents the traveling direction of the railway vehicle, and the Y axis represents the width direction of the railway vehicle. The Z axis is orthogonal to the X and Y axes. The Z axis represents the vertical direction while the railway vehicle is horizontally oriented. The same holds true for the subsequent drawings.

The motor 61 is a source of motive power, which is driven by electric power fed from the power supply and generates rotational force. The driven motor 61 rotates the output shaft 62 of the motor 61. One end of the output shaft 62 is coupled to the joint 63.

The joint 63, a typical example of which is a Cardan joint including flexible plates, transfers the rotational force received from the output shaft 62, to the gear mechanism 1 via the driving shaft 64.

The driving shaft 64 has one end attached to the gear mechanism 1, and the other end attached to the joint 63. The driving shaft 64 is rotated about a rotational axis AX1 by the motor 61 serving as a source of motive power. The description assumes that the rotational axis AX1 extends in parallel to the Y axis.

The axle 65 is a driven shaft that rotates in accordance with rotation of the driving shaft 64. In detail, the axle 65 is coupled to the gear mechanism 1. When receiving rotational force from the driving shaft 64 via the gear mechanism 1, the axle 65 rotates integrally with the wheels 66 about a rotational axis AX2. The description assumes that the rotational axis AX2 extends in parallel to the Y axis.

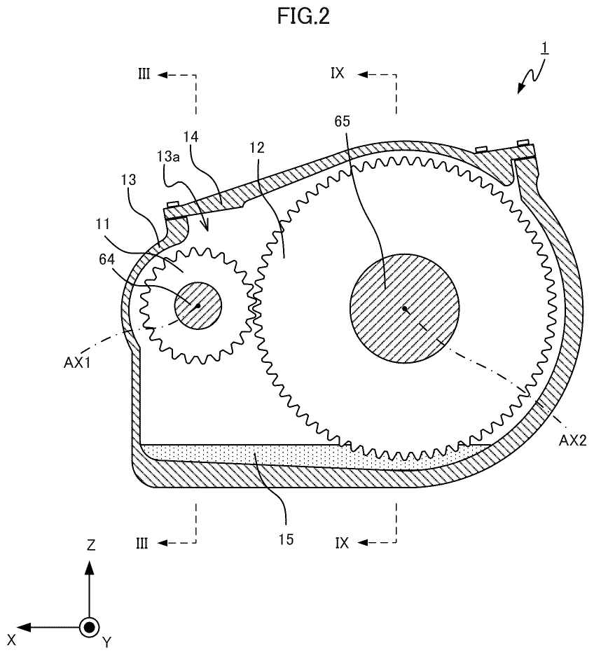

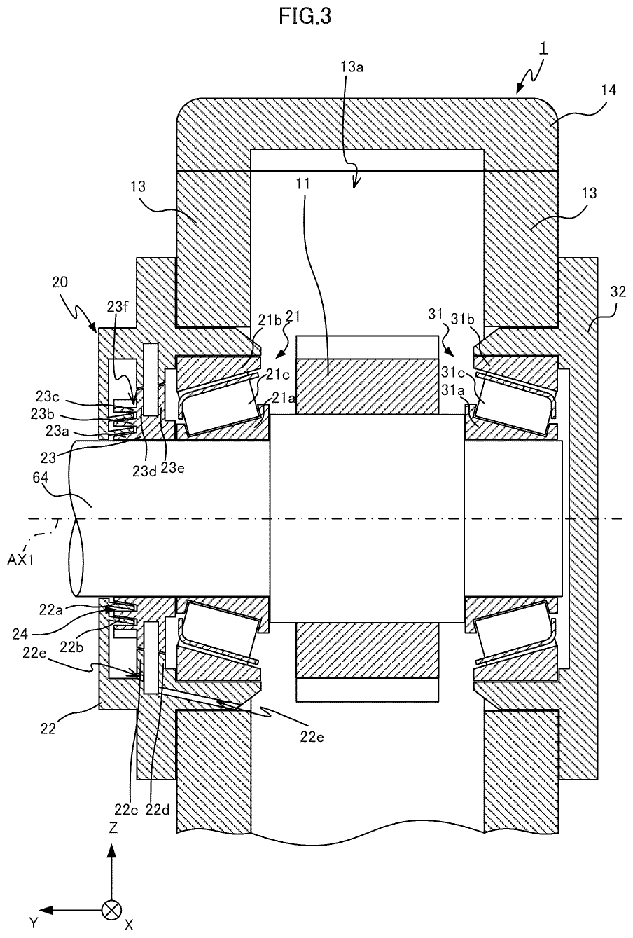

The gear mechanism 1 includes at least one gear, and at least one bearing that supports a shaft provided with the gear such that the shaft is rotatable. As illustrated in FIG. 2, which is a sectional view taken along the line II-II of FIG. 1, and FIG. 3, which is a sectional view taken along the line III-III of FIG. 2, the gear mechanism 1 includes a gear 11, and bearings 21 and 31 that support the shaft on the driving side, specifically, the driving shaft 64 provided with the gear 11 such that the driving shaft 64 is rotatable. The gear mechanism 1 further includes a gear 12, and a pair of bearings that support the shaft on the driven side, specifically, the axle 65 provided with the gear 12 such that the axle 65 is rotatable.

The following description refers to the gear 11 attached to the driving shaft 64 as “driving gear 11”, and refers to the gear 12 attached to the axle 65 serving as a driven shaft such that the gear 12 meshes with the driving gear 11 as “driven gear 12, for the purpose of discrimination. The description refers to the bearings 21 and 31 that support the driving shaft 64 such that the driving shaft 64 is rotatable as “first bearing 21” and “second bearing 31”, respectively, for the purpose of discrimination.

The gear mechanism 1 also includes a first bearing retainer 22 that retains the first bearing 21, and an oil thrower 23 attached to the driving shaft 64 at a position between the first bearing retainer 22 and the first bearing 21. Specifically, the annular oil thrower 23 is attached to the driving shaft 64 at a position opposed in the radial direction to a tubular base of the first bearing retainer 22 that extends in the direction of the rotational axis AX1. In Embodiment 1, the oil thrower 23 is located between the first bearing 21 and the end face of the first bearing retainer 22 on the positive side in the Y-axis direction, on the radial inside of the first bearing retainer 22. The first bearing 21, the first bearing retainer 22, and the oil thrower 23 are referred to as “bearing unit 20” as a whole.

The gear mechanism 1 further includes a second bearing retainer 32 that retains the second bearing 31, a gear housing 13 that accommodates the driving gear 11, the driven gear 12, the first bearing 21, the oil thrower 23, and the second bearing 31, and a lid 14 that closes an upper opening 13a located at the vertically upper portion of the gear housing 13. The gear housing 13 accommodates a lubricant 15 enclosed therein.

The individual components of the gear mechanism 1 are described in detail below. As illustrated in FIGS. 2 and 3, the driving gear 11 is attached to the driving shaft 64, and rotates integrally with the driving shaft 64. That is, in response to rotation of the output shaft 62 of the motor 61, the driving gear 11 rotates integrally with the driving shaft 64, which rotates by receiving rotational force from the motor 61 via the joint 63.

As illustrated in FIG. 2, the driven gear 12 is attached to the axle 65 such that the driven gear 12 meshes with the driving gear 11. In detail, the driven gear 12 is attached to the axle 65 by interference fitting. The driven gear 12 rotates integrally with the axle 65, in accordance with rotation of the driving gear 11. In Embodiment 1, the driven gear 12 has a larger radius and a larger number of teeth than the driving gear 11.

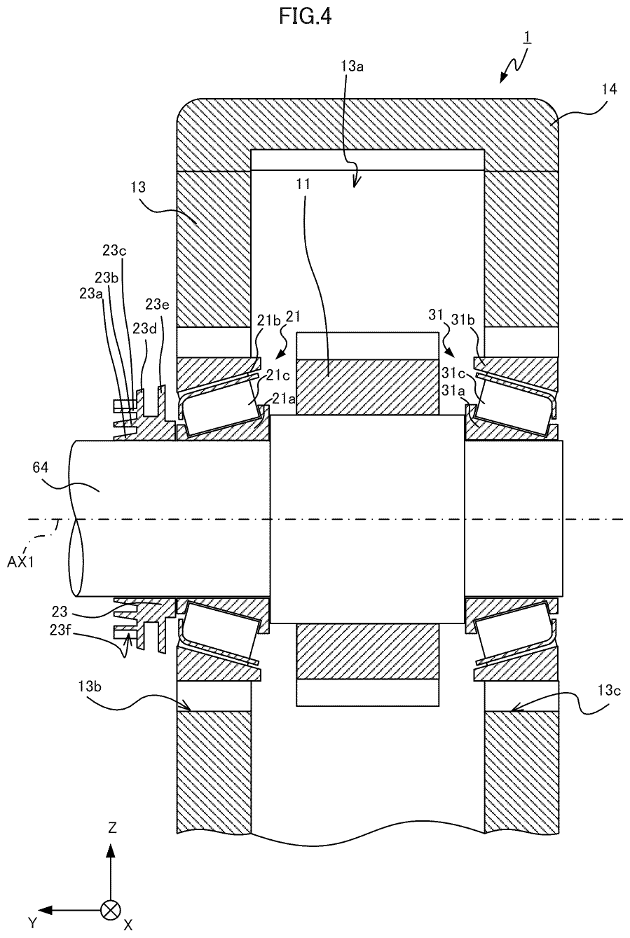

As illustrated in FIGS. 2 and 3, the gear housing 13 has a box shape and has the upper opening 13a in the vertically upper portion. As illustrated in FIG. 4, depicted by removing the first bearing retainer 22 and the second bearing retainer 32 from FIG. 3, the two surfaces of the gear housing 13 that intersect the Y axis respectively have first openings 13b and 13c. The first opening 13b receives the driving shaft 64 inserted therethrough. The first opening 13b has such a shape and size as to allow the driving gear 11 to be extracted through the first opening 13b, for the purpose of maintenance of the driving gear 11. The first opening 13c has the same shape and size as the first opening 13b. The two surfaces of the gear housing 13 that intersect the Y axis also have a pair of second openings that receive the axle 65 inserted therethrough, although these openings are not illustrated.

The lid 14 is mounted on the gear housing 13 such that the lid 14 closes the upper opening 13a of the gear housing 13. The lid 14 is fixed to the gear housing 13, for example, with fastening members.

The lubricant 15 is enclosed in the gear housing 13. In detail, the lubricant 15 enclosed in the gear housing 13 has such an amount that a vertically lower portion of the driven gear 12 soaks in the lubricant 15. The rotation of the driven gear 12 brings up the lubricant 15. A part of the brought lubricant 15 reaches the pair of bearings that support the axle 65 such that the axle 65 is rotatable. Another part of the brought lubricant 15 reaches the portions of the driven gear 12 and the driving gear 11 that mesh with each other. This lubricant 15 is scattered when the driven gear 12 meshes with the driving gear 11, and thus reaches the first bearing 21 and the second bearing 31 that support the driving shaft 64 such that the driving shaft 64 is rotatable. That is, the lubricant 15 is supplied to and thus lubricates the pair of bearings that support the axle 65 such that the axle 65 is rotatable, the portions of the driven gear 12 and the driving gear 11 that mesh with each other, the first bearing 21, and the second bearing 31.

The first bearing 21 supports the driving shaft 64 such that the driving shaft 64 is rotatable. In detail, the first bearing 21 includes an inner race 21a attached to the driving shaft 64 and rotating integrally with the driving shaft 64, an outer race 21b retained by the first bearing retainer 22, and rolling elements 21c located between the inner race 21a and the outer race 21b and rolling in accordance with rotation of the inner race 21a.

The first bearing retainer 22 has a through hole that receives the driving shaft 64 inserted therethrough. The first bearing retainer 22 retains the first bearing 21, which supports the driving shaft 64 such that the driving shaft 64 is rotatable, while the driving shaft 64 is disposed through the through hole. The first bearing 21 is press fitted to the first bearing retainer 22, for example. The first bearing retainer 22 is attached to the gear housing 13 such that the first bearing retainer 22 closes the first opening 13b of the gear housing 13 illustrated in FIG. 4. For example, the first bearing retainer 22 closes the first opening 13b such that the tubular base extending in the direction of the rotational axis AX1 is partially disposed in the first opening 13b. As illustrated in FIG. 3, the inner periphery of the first bearing retainer 22 and the driving shaft 64 are arranged with a space therebetween in the radial direction. This arrangement allows for rotation of the driving shaft 64.

The oil thrower 23 is attached to the driving shaft 64, and rotates integrally with the driving shaft 64. The oil thrower 23 extends toward the first bearing retainer 22, and defines a labyrinth structure against the first bearing retainer 22. The labyrinth structure indicates complicated channels that avoid linear movements of fluid. The labyrinth structure thus suppresses leakage of the lubricant 15 from the gear housing 13 through the gap between the inner periphery of the first bearing retainer 22 and the driving shaft 64.

The second bearing 31 holds the driving gear 11 against the first bearing 21 of the bearing unit 20, and supports one end of the driving shaft 64 such that the driving shaft 64 is rotatable. The second bearing 31 includes an inner race 31a attached to the driving shaft 64 and rotating integrally with the driving shaft 64, an outer race 31b retained by the second bearing retainer 32, and rolling elements 31c located between the inner race 31a and the outer race 31b and rolling in accordance with rotation of the inner race 31a.

The second bearing retainer 32 retains the second bearing 31. The second bearing 31 is press fitted to the second bearing retainer 32, for example. The second bearing retainer 32 is attached to the gear housing 13 such that the second bearing retainer 32 closes the first opening 13c of the gear housing 13 illustrated in FIG. 4.

The gear mechanism 1 having the above-described configuration has a structure for suppressing leakage of the lubricant 15 enclosed in the gear housing 13 to the outside. The structure for suppressing leakage of the lubricant 15 to the outside is described in detail below.

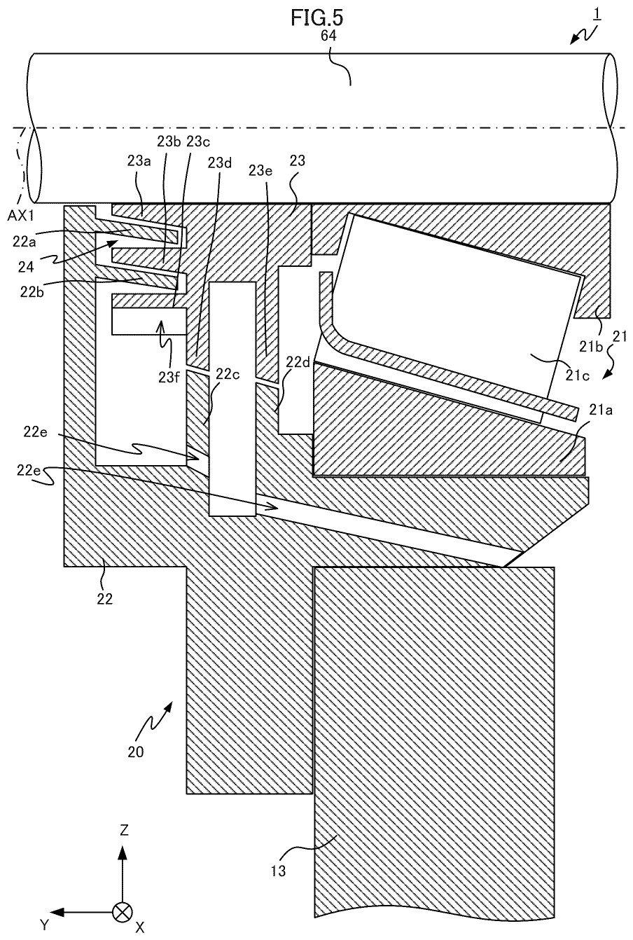

As illustrated in FIG. 3 and FIG. 5, which is a partially enlarged view of FIG. 3, the first bearing retainer 22 includes one or more first tubular segments having a tubular shape. The first tubular segments extend in the direction of the rotational axis AX1 of the driving shaft 64, that is, in the Y-axis direction, and defines a labyrinth structure 24 against the oil thrower 23. In Embodiment 1, the first bearing retainer 22 includes first tubular segments 22a and 22b. The first tubular segments 22a and 22b each have a tubular shape of which the inner diameter increases toward the oil thrower 23, in other words, toward a negative Y-axis direction.

The first tubular segments 22a and 22b are located adjacent to each other in the radial direction. The radial direction indicates the direction orthogonal to the rotational axis AX1. In detail, the first tubular segment 22b is located on the radial outside of the first tubular segment 22a, and the outer periphery of the first tubular segment 22a and the inner periphery of the first tubular segment 22b are opposed to each other with a space therebetween in the radial direction.

The first bearing retainer 22 preferably further includes one or more first annular segments having an annular shape. The first annular segments extend toward the oil thrower 23 in the radial direction. In Embodiment 1, the first bearing retainer 22 includes first annular segments 22c and 22d that extend radially inward from the tubular base. The first annular segments 22c and 22d are arranged with a space therebetween in the direction of the rotational axis AX1 of the driving shaft 64.

The first bearing retainer 22 has a channel 22e in the vertically lower portion. The channel 22e guides the lubricant 15 to the vertically lower portion of the gear housing 13.

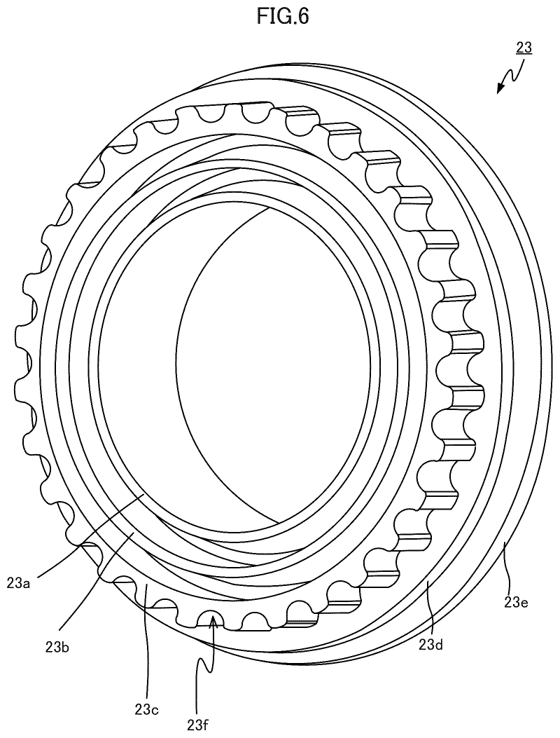

As illustrated in FIGS. 5 and 6, the oil thrower 23 includes one or more second tubular segments having a tubular shape. The second tubular segments extend in the direction of the rotational axis AX1 of the driving shaft 64 toward the first bearing retainer 22. In Embodiment 1, the oil thrower 23 includes second tubular segments 23a, 23b, and 23c. As illustrated in FIG. 5, the second tubular segments 23a, 23b, and 23c are located adjacent to each other in the radial direction. In detail, the outer periphery of the second tubular segment 23a and the inner periphery of the second tubular segment 23b are opposed to each other with a space therebetween in the radial direction. The outer periphery of the second tubular segment 23b and the inner periphery of the second tubular segment 23c are opposed to each other with a space therebetween in the radial direction.

In Embodiment 1, the second tubular segments 23a and 23b each have a tapered shape of which the radial thickness decreases toward the first bearing retainer 22, in other words, toward a positive Y-axis direction. This structure can sufficiently narrow the radial distances from the first tubular segments 22a and 22b, having a tubular shape of which the inner diameter increases toward the oil thrower 23, to the second tubular segments 23a and 23b, to distances that can suppress transfer of the lubricant 15. In detail, the outer periphery of the second tubular segment 23a is disposed along the inner periphery of the first tubular segment 22a, and the outer periphery of the second tubular segment 23b is disposed along the inner periphery of the first tubular segment 22b. This structure narrows the radial distances from the first tubular segments 22a and 22b to the second tubular segments 23a and 23b, and suppresses transfer of the lubricant 15.

The oil thrower 23 further includes one or more second annular segments having an annular shape. The second annular segments extend in the radial direction toward the first bearing retainer 22, as illustrated in FIGS. 5 and 6. In Embodiment 1, the oil thrower 23 includes second annular segments 23d and 23e. The second annular segments 23d and 23e are arranged with a space therebetween in the direction of the rotational axis AX1 of the driving shaft 64.

As illustrated in FIG. 5, the ends of the second tubular segments 23a, 23b, and 23c near the first bearing retainer 22 define the labyrinth structure 24 against the first bearing retainer 22. In detail, the ends of the second tubular segments 23a, 23b, and 23c near the first bearing retainer 22 are located adjacent to the first tubular segments 22a and 22b in the radial direction, and thus define the labyrinth structure 24 between the first bearing retainer 22 and the second tubular segments 23a, 23b, and 23c. In detail, the outer periphery of the second tubular segment 23a is opposed to the inner periphery of the first tubular segment 22a, the outer periphery of the first tubular segment 22a is opposed to the inner periphery of the second tubular segment 23b, the outer periphery of the second tubular segment 23b is opposed to the inner periphery of the first tubular segment 22b, and the outer periphery of the first tubular segment 22b is opposed to the inner periphery of the second tubular segment 23c. This arrangement achieves the labyrinth structure 24.

For example, the distance between the outer periphery of the second tubular segment 23a and the inner periphery of the first tubular segment 22a and the distance between the outer periphery of the first tubular segment 22a and the inner periphery of the second tubular segment 23b are preferably 0.1 mm or larger and 2.0 mm or smaller.

The first annular segments 22c and 22d of the first bearing retainer 22 attached to the gear housing 13 are respectively located adjacent to the second annular segments 23d and 23e of the oil thrower 23 that rotates integrally with the driving shaft 64, with spaces therebetween in the radial direction. For example, the distance between the first annular segment 22c or 22d and the second annular segment 23d or 23e is preferably 0.1 mm or larger and 2.0 mm or smaller.

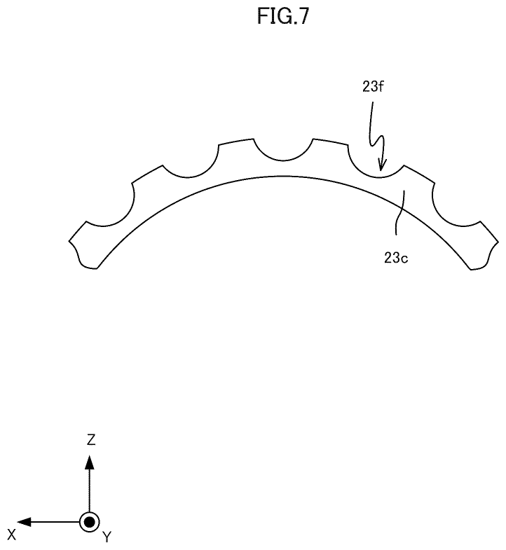

As illustrated in FIG. 6 and FIG. 7, which is a partially enlarged view of the oil thrower 23 when viewed in the negative Y-axis direction, the second tubular segment 23c having the largest outer diameter among the second tubular segments 23a, 23b, and 23c of the oil thrower 23 has multiple grooves 23f circumferentially arranged on the outer periphery. In Embodiment 1, the second tubular segment 23c has a radial thickness larger than the radial thicknesses of the second tubular segments 23a and 23b. That is, the second tubular segment 23c having a larger thickness has the grooves 23f extending in the direction of the rotational axis AX1. In Embodiment 1, the grooves 23f are each defined by a curved wall having an arc shape in the XZ plane, as illustrated in FIG. 7.

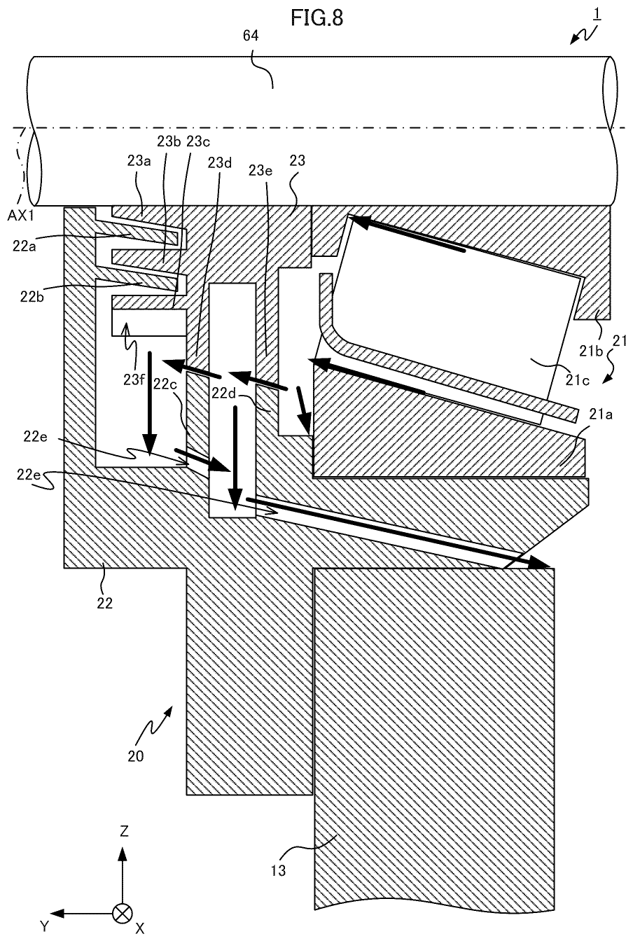

FIG. 8 illustrates an example of flows of the lubricant 15 in the gear mechanism 1 having the above-described configuration, with solid-line arrows. FIG. 8 illustrates only some of the flows of the lubricant 15 in order to simplify the figure. The lubricant 15, which flows from the driving gear 11 in the positive Y-axis direction and adheres to the first bearing 21, travels through the gaps between the rolling elements 21c and the inner race 21a or the gaps between the rolling elements 21c and the outer race 21b in the positive Y-axis direction.

The sufficiently narrow gaps between the first annular segments 22c and 22d and the second annular segments 23d and 23e can reduce the amount of the lubricant 15 that enters the first bearing retainer 22 through the first bearing 21.

In detail, a part of the lubricant 15 that flows from the first bearing 21 in the positive Y-axis direction fails to pass through the gap between the first annular segment 22d and the second annular segment 23e, travels radially outward along the first annular segment 22d, and returns to the first bearing 21. The other part of the lubricant 15 that flows from the first bearing 21 in the positive Y-axis direction passes through the gap between the first annular segment 22d and the second annular segment 23e.

A part of the lubricant 15 that passes through the gap between the first annular segment 22d and the second annular segment 23e fails to pass through the gap between the first annular segment 22c and the second annular segment 23d, travels radially outward along the first annular segment 22c, and returns through the channel 22e to the vertically lower portion of the gear housing 13. The other part of the lubricant 15 that passes through the gap between the first annular segment 22d and the second annular segment 23e passes through the gap between the first annular segment 22c and the second annular segment 23d.

The labyrinth structure 24 suppresses radial inward flow of the lubricant 15 passing through the gap between the first annular segment 22c and the second annular segment 23d. Thereby, suppressing the flow of the lubricant 15 exiting the gear housing 13 through the gap between the first bearing retainer 22 and the driving shaft 64.

The grooves 23f allow the second tubular segment 23c of the oil thrower 23, which rotates integrally with the driving shaft 64, to serve as a fan, and generate radially outward airflows. The airflows facilitate the lubricant 15 that passes through the gap between the first annular segment 22c and the second annular segment 23d to travel radially outward. The lubricant 15 traveling radially outward returns through the channel 22e to the vertically lower portion of the gear housing 13.

Since the joint 63 is made of a Cardan joint including flexible plates, the rotation of the driving shaft 64 may induce a negative pressure around the driving shaft 64 outside the gear housing 13. Even in this case, the second tubular segment 23c having the grooves 23f also serves as a fan and generates radial airflows, and thus facilitates the lubricant 15 to flow in the radial direction and suppresses leakage of the lubricant 15 from the gear housing 13.

As described above, the bearing unit 20 according to Embodiment 1 includes the second tubular segment 23c having the grooves 23f circumferentially arranged on the outer periphery, and the oil thrower 23 that defines the labyrinth structure 24 against the first bearing retainer 22. The bearing unit 20, when installed in the gear housing 13 of the gear mechanism 1, can thus suppress leakage of the lubricant 15 enclosed in the gear housing 13.

### Embodiment 2

The bearing unit 20 may be applied to, not only the component illustrated in Embodiment 1, but also the pair of bearings that support the axle 65 serving as a driven shaft such that the axle 65 is rotatable. The description of Embodiment 2 focuses on another exemplary gear mechanism 1 including a pair of driven-shaft bearing units that support the axle 65 such that the axle 65 is rotatable, which have the same structure as the bearing unit 20.

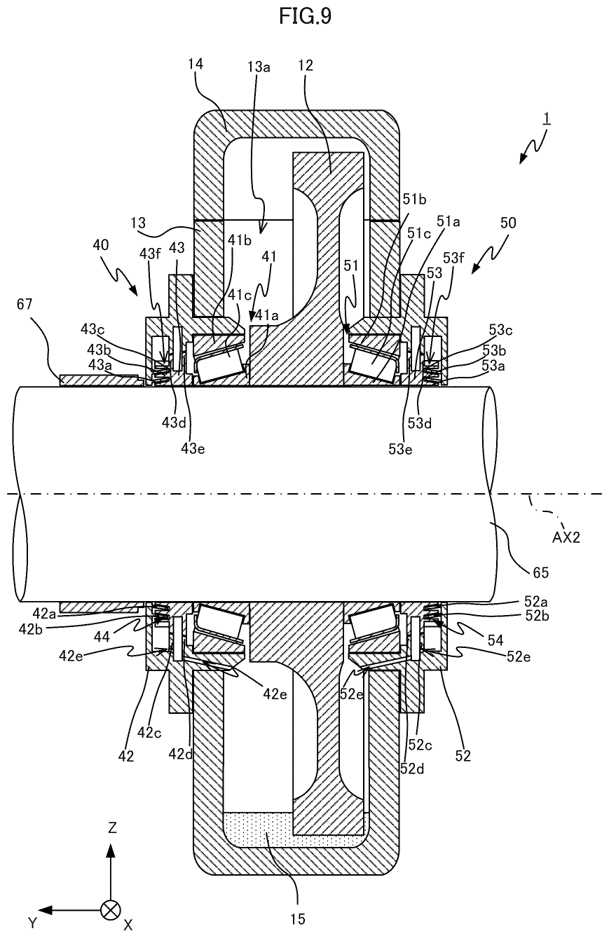

The gear mechanism 1 illustrated in FIG. 9 includes, as the pair of driven-shaft bearing units, bearing units 40 and 50 that support the axle 65 such that the axle 65 is rotatable. The gear mechanism 1 also includes a ground ring 67 attached to the axle 65. The gear mechanism 1 according to Embodiment 2 has the structures that support the driving shaft 64 such that the driving shaft 64 is rotatable, specifically, has the bearing unit 20, the second bearing 31, and the second bearing retainer 32, as in Embodiment 1, although these structures are not illustrated.

The bearing units 40 and 50 have the same configuration as the bearing unit 20. In detail, the bearing unit 40 includes a first bearing 41 that supports the axle 65 such that the axle 65 is rotatable, a first bearing retainer 42 that retains the first bearing 41, and an oil thrower 43 attached to the axle 65 at a position between the first bearing retainer 42 and the first bearing 41. Specifically, the annular oil thrower 43 is attached to the axle 65 at a position opposed in the radial direction to a tubular base of the first bearing retainer 42 that extends in the direction of the rotational axis AX2. In Embodiment 2, the oil thrower 43 is located between the first bearing 41 and the end face of the first bearing retainer 42 on the positive side in the Y-axis direction, on the radial inside of the first bearing retainer 42.

The bearing unit 50 includes a first bearing 51 that supports the axle 65 such that the axle 65 is rotatable, a first bearing retainer 52 that retains the first bearing 51, and an oil thrower 53 attached to the axle 65 at a position between the first bearing retainer 52 and the first bearing 51. Specifically, the annular oil thrower 53 is attached to the axle 65 at a position opposed in the radial direction to a tubular base of the first bearing retainer 52 that extends in the direction of the rotational axis AX2. In Embodiment 2, the oil thrower 53 is located between the first bearing 51 and the end face of the first bearing retainer 52 on the negative side in the Y-axis direction, on the radial inside of the first bearing retainer 52.

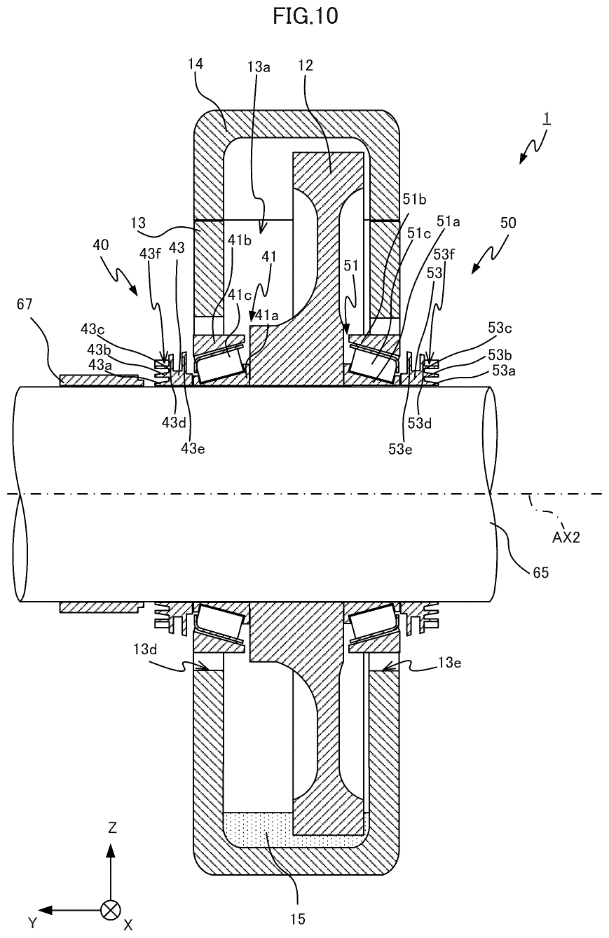

As illustrated in FIG. 10, which is depicted by removing the first bearing retainers 42 and 52 from FIG. 9, the two surfaces of the gear housing 13 that intersect the Y axis respectively have second openings 13d and 13e that receive the axle 65 inserted therethrough.

The ground ring 67 illustrated in FIGS. 9 and 10 is attached to the axle 65 at a position adjacent to the bearing unit 40. In detail, the ground ring 67 is attached to the axle 65 on the positive side in the Y-axis direction of the bearing unit 40. The ground ring 67 is made of an electrically conductive material. The ground ring 67 guides current from the vehicle body of the railway vehicle to rails, via a ground brush, which is not illustrated. The ground ring 67 is firmly bonded to the axle 65 so as not to be displaced in the Y-axis direction during rotation of the axle 65. The ground ring 67 is press fitted to the axle 65, for example.

The first bearing 41 supports the axle 65 such that the axle 65 is rotatable. In detail, the first bearing 41 includes an inner race 41a attached to the axle 65 and rotating integrally with the axle 65, an outer race 41b retained by the first bearing retainer 42, and rolling elements 41c located between the inner race 41a and the outer race 41b and rolling in accordance with rotation of the inner race 41a.

The first bearing retainer 42 has a through hole that receives the axle 65 inserted therethrough. The first bearing retainer 42 retains the first bearing 41, which supports the axle 65 such that the axle 65 is rotatable, while the axle 65 is disposed through the through hole. The first bearing 41 is press fitted to the first bearing retainer 42, for example. The first bearing retainer 42 is attached to the gear housing 13 such that the first bearing retainer 42 closes the second opening 13d of the gear housing 13 illustrated in FIG. 10. For example, the first bearing retainer 42 closes the second opening 13d such that the tubular base extending in the direction of the rotational axis AX2 is partially disposed in the second opening 13d. As illustrated in FIG. 9, the inner periphery of the first bearing retainer 42 and the axle 65 are arranged with a space therebetween in the radial direction. This arrangement allows for rotation of the axle 65.

The oil thrower 43 is attached to the axle 65, and rotates integrally with the axle 65. The oil thrower 43 extends toward the first bearing retainer 42, and defines a labyrinth structure 44 against the first bearing retainer 42. This labyrinth structure 44 suppresses leakage of the lubricant 15 from the gear housing 13 via the second opening 13d.

The first bearing 51 supports the axle 65 such that the axle 65 is rotatable. In detail, the first bearing 51 includes an inner race 51a attached to the axle 65 and rotating integrally with the axle 65, an outer race 51b retained by the first bearing retainer 52, and rolling elements 51c located between the inner race 51a and the outer race 51b and rolling in accordance with rotation of the inner race 51a.

The first bearing retainer 52 has a through hole that receives the axle 65 inserted therethrough. The first bearing retainer 52 retains the first bearing 51, which supports the axle 65 such that the axle 65 is rotatable, while the axle 65 is disposed through the through hole. The first bearing 51 is press fitted to the first bearing retainer 52, for example. The first bearing retainer 52 is attached to the gear housing 13 such that the first bearing retainer 52 closes the second opening 13e illustrated in FIG. 10. For example, the first bearing retainer 52 closes the second opening 13e such that the tubular base extending in the direction of the rotational axis AX2 is partially disposed in the second opening 13e. As illustrated in FIG. 9, the first bearing retainer 52 and the axle 65 are arranged with a space therebetween in the radial direction. This arrangement allows for rotation of the axle 65.

The oil thrower 53 is attached to the axle 65, and rotates integrally with the axle 65. The oil thrower 53 extends toward the first bearing retainer 52, and defines a labyrinth structure 54 against the first bearing retainer 52. This labyrinth structure 54 suppresses leakage of the lubricant 15 from the gear housing 13 via the second opening 13e.

The gear mechanism 1 according to Embodiment 2 has the same configuration as that in Embodiment 1, and suppresses leakage of the lubricant 15 to the outside via the first openings 13b and 13c. The following describes the detailed structure of the gear mechanism 1 according to Embodiment 2 for suppressing leakage of the lubricant 15 to the outside via the second openings 13d and 13e.

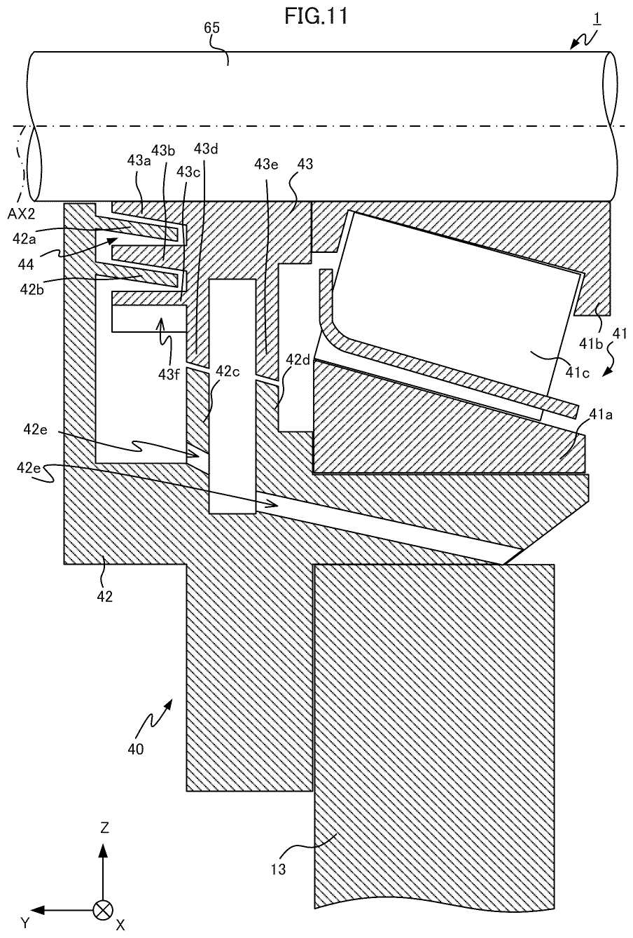

As illustrated in FIG. 9 and FIG. 11, which is a partially enlarged view of FIG. 9, the first bearing retainer 42 includes first tubular segments having a tubular shape, like the first bearing retainer 22 of the gear mechanism 1 according to Embodiment 1. In detail, the first bearing retainer 42 includes one or more first tubular segments that extend in the direction of the rotational axis AX2 of the axle 65, that is, in the Y-axis direction, and defines the labyrinth structure 44 against the oil thrower 43. In Embodiment 2, the first bearing retainer 42 includes first tubular segments 42a and 42b. The first tubular segments 42a and 42b each have a tubular shape of which the inner diameter increases toward the oil thrower 43, in other words, toward the negative Y-axis direction.

The first tubular segments 42a and 42b are located adjacent to each other in the radial direction. The radial direction indicates the direction orthogonal to the rotational axis AX2. In detail, the first tubular segment 42b is located on the radial outside of the first tubular segment 42a, and the outer periphery of the first tubular segment 42a and the inner periphery of the first tubular segment 42b are opposed to each other with a space therebetween in the radial direction.

The first bearing retainer 42 preferably further includes one or more first annular segments having an annular shape. The first annular segments extend toward the oil thrower 43 in the radial direction. In Embodiment 2, the first bearing retainer 42 includes first annular segments 42c and 42d that extend radially inward from the tubular base. The first annular segments 42c and 42d are arranged with a space therebetween in the direction of the rotational axis AX2 of the axle 65.

The first bearing retainer 42 has a channel 42e in the vertically lower portion. The channel 42e guides the lubricant 15 to the vertically lower portion of the gear housing 13.

The oil thrower 43 includes one or more second tubular segments having a tubular shape, like the oil thrower 23 of the gear mechanism 1 according to Embodiment 1. The second tubular segments extend in the direction of the rotational axis AX2 of the axle 65 toward the first bearing retainer 42. In Embodiment 2, the oil thrower 43 includes second tubular segments 43a, 43b, and 43c. The second tubular segments 43a, 43b, and 43c are located adjacent to each other in the radial direction. In detail, the outer periphery of the second tubular segment 43a and the inner periphery of the second tubular segment 43b are opposed to each other with a space therebetween in the radial direction. The outer periphery of the second tubular segment 43b and the inner periphery of the second tubular segment 43c are opposed to each other with a space therebetween in the radial direction.

In Embodiment 2, the second tubular segments 43a and 43b each have a tapered shape of which the radial thickness decreases toward the first bearing retainer 42, in other words, toward the positive Y-axis direction. This structure can sufficiently narrow the radial distances from the first tubular segments 42a and 42b, having a tubular shape of which the inner diameter increases toward the oil thrower 43, to the second tubular segments 43a and 43b, to distances that can reduce transfer of the lubricant 15. In detail, the outer periphery of the second tubular segment 43a is disposed along the inner periphery of the first tubular segment 42a, and the outer periphery of the second tubular segment 43b is disposed along the inner periphery of the first tubular segment 42b. This structure narrows the radial distances from the first tubular segments 42a and 42b to the second tubular segments 43a and 43b, and suppresses transfer of the lubricant 15.

The oil thrower 43 further includes one or more second annular segments having an annular shape. The second annular segments extend in the radial direction toward the first bearing retainer 42. In Embodiment 2, the oil thrower 43 includes second annular segments 43d and 43e. The second annular segments 43d and 43e are arranged with a space therebetween in the direction of the rotational axis AX2 of the axle 65.

The ends of the second tubular segments 43a, 43b, and 43c near the first bearing retainer 42 are located adjacent to the first tubular segments 42a and 42b in the radial direction, and thus define the labyrinth structure 44 between the first bearing retainer 42 and the second tubular segments 43a, 43b, and 43c. In detail, the outer periphery of the second tubular segment 43a is opposed to the inner periphery of the first tubular segment 42a, the outer periphery of the first tubular segment 42a is opposed to the inner periphery of the second tubular segment 43b, the outer periphery of the second tubular segment 43b is opposed to the inner periphery of the first tubular segment 42b, and the outer periphery of the first tubular segment 42b is opposed to the inner periphery of the second tubular segment 43c. This arrangement achieves the labyrinth structure 44.

For example, the distance between the outer periphery of the second tubular segment 43a and the inner periphery of the first tubular segment 42a and the distance between the outer periphery of the first tubular segment 42a and the inner periphery of the second tubular segment 43b are preferably 0.1 mm or larger and 2.0 mm or smaller.

The first annular segments 42c and 42d of the first bearing retainer 42 attached to the gear housing 13 are respectively located adjacent to the second annular segments 43d and 43e of the oil thrower 43 that rotates integrally with the axle 65, with spaces therebetween in the radial direction. For example, the distance between the first annular segment 42c or 42d and the second annular segment 43d or 43e is preferably 0.1 mm or larger and 2.0 mm or smaller.

The second tubular segment 43c having the largest outer diameter among the second tubular segments 43a, 43b, and 43c of the oil thrower 43 has multiple grooves 43f circumferentially arranged on the outer periphery, as in Embodiment 1. In Embodiment 2, the second tubular segment 43c has a radial thickness larger than the radial thicknesses of the second tubular segments 43a and 43b. That is, the second tubular segment 43c having a larger thickness has the grooves 43f extending in the direction of the rotational axis AX2. The grooves 43f are each defined by a curved wall having an arc shape in the XZ plane, as in Embodiment 1.

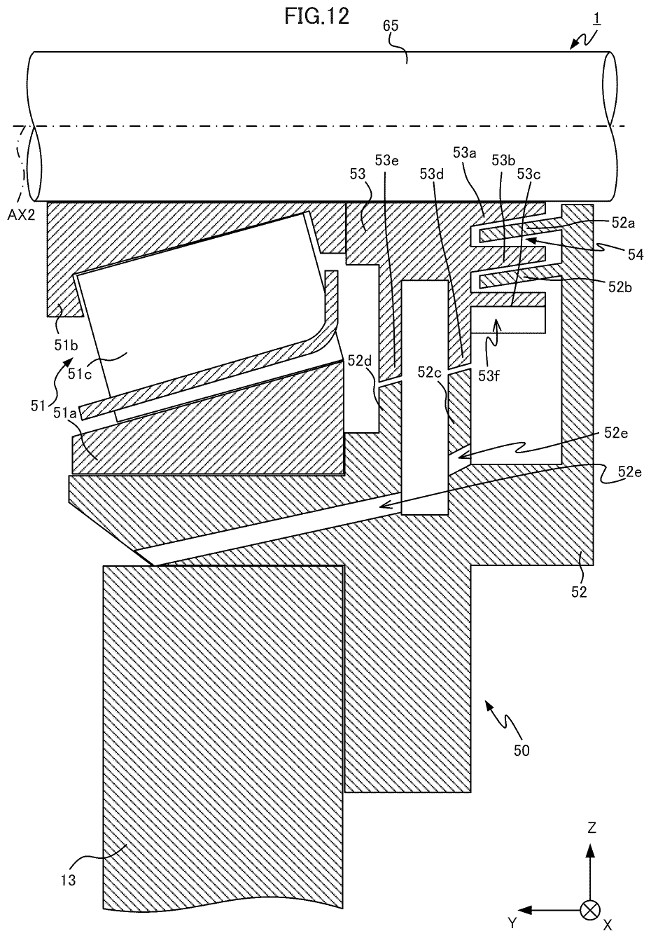

As illustrated in FIG. 9 and FIG. 12, which is a partially enlarged view of FIG. 9, the first bearing retainer 52 includes first tubular segments having a tubular shape, like the first bearing retainer 22 of the gear mechanism 1 according to Embodiment 1. In detail, the first bearing retainer 52 includes one or more first tubular segments that extend in the direction of the rotational axis AX2 of the axle 65, that is, in the Y-axis direction, and defines the labyrinth structure 54 against the oil thrower 53. In Embodiment 2, the first bearing retainer 52 includes first tubular segments 52a and 52b. The first tubular segments 52a and 52b each have a tubular shape of which the inner diameter increases toward the oil thrower 53, in other words, toward the positive Y-axis direction.

The first tubular segments 52a and 52b are located adjacent to each other in the radial direction. The radial direction indicates the direction orthogonal to the rotational axis AX2. In detail, the first tubular segment 52b is located on the radial outside of the first tubular segment 52a, and the outer periphery of the first tubular segment 52a and the inner periphery of the first tubular segment 52b are opposed to each other with a space therebetween in the radial direction.

The first bearing retainer 52 preferably further includes one or more first annular segments having an annular shape. The first annular segments extend toward the oil thrower 53 in the radial direction. In Embodiment 2, the first bearing retainer 52 includes first annular segments 52c and 52d that extend radially inward from the tubular base. The first annular segments 52c and 52d are arranged with a space therebetween in the direction of the rotational axis AX2 of the axle 65.

The first bearing retainer 52 has a channel 52e in the vertically lower portion. The channel 52e guides the lubricant 15 to the vertically lower portion of the gear housing 13.

The oil thrower 53 includes one or more second tubular segments having a tubular shape, like the oil thrower 23 of the gear mechanism 1 according to Embodiment 1. The second tubular segments extend in the direction of the rotational axis AX2 of the axle 65 toward the first bearing retainer 52. In Embodiment 2, the oil thrower 53 includes second tubular segments 53a, 53b, and 53c. The second tubular segments 53a, 53b, and 53c are located adjacent to each other in the radial direction. In detail, the outer periphery of the second tubular segment 53a and the inner periphery of the second tubular segment 53b are opposed to each other with a space therebetween in the radial direction. The outer periphery of the second tubular segment 53b and the inner periphery of the second tubular segment 53c are opposed to each other with a space therebetween in the radial direction.

In Embodiment 2, the second tubular segments 53a and 53b each have a tapered shape of which the radial thickness decreases toward the first bearing retainer 52, in other words, toward the negative Y-axis direction. This structure can sufficiently narrow the radial distances from the first tubular segments 52a and 52b, having a tubular shape of which the inner diameter increases toward the oil thrower 53, to the second tubular segments 53a and 53b, to distances that can reduce transfer of the lubricant 15. In detail, the outer periphery of the second tubular segment 53a is disposed along the inner periphery of the first tubular segment 52a, and the outer periphery of the second tubular segment 53b is disposed along the inner periphery of the first tubular segment 52b. This structure narrows the radial distances from the first tubular segments 52a and 52b to the second tubular segments 53a and 53b, and reduces transfer of the lubricant 15.

The oil thrower 53 further includes one or more second annular segments having an annular shape. The second annular segments extend in the radial direction toward the first bearing retainer 52. In Embodiment 2, the oil thrower 53 includes second annular segments 53d and 53e. The second annular segments 53d and 53e are arranged with a space therebetween in the direction of the rotational axis AX2 of the axle 65.

The ends of the second tubular segments 53a, 53b, and 53c near the first bearing retainer 52 are located adjacent to the first tubular segments 52a and 52b in the radial direction, and thus define the labyrinth structure 54 between the first bearing retainer 52 and the second tubular segments 53a, 53b, and 53c. In detail, the outer periphery of the second tubular segment 53a is opposed to the inner periphery of the first tubular segment 52a, the outer periphery of the first tubular segment 52a is opposed to the inner periphery of the second tubular segment 53b, the outer periphery of the second tubular segment 53b is opposed to the inner periphery of the first tubular segment 52b, and the outer periphery of the first tubular segment 52b is opposed to the inner periphery of the second tubular segment 53c. This arrangement achieves the labyrinth structure 54.

For example, the distance between the outer periphery of the second tubular segment 53a and the inner periphery of the first tubular segment 52a and the distance between the outer periphery of the first tubular segment 52a and the inner periphery of the second tubular segment 53b are preferably 0.1 mm or larger and 2.0 mm or smaller.

The first annular segments 52c and 52d of the first bearing retainer 52 attached to the gear housing 13 are respectively located adjacent to the second annular segments 53d and 53e of the oil thrower 53 that rotates integrally with the axle 65, with spaces therebetween in the radial direction. For example, the distance between the first annular segment 52c or 52d and the second annular segment 53d or 53e is preferably 0.1 mm or larger and 2.0 mm or smaller.

The second tubular segment 53c having the largest outer diameter among the second tubular segments 53a, 53b, and 53c of the oil thrower 53 have multiple grooves 53f circumferentially arranged on the outer periphery, as in Embodiment 1. In Embodiment 2, the second tubular segment 53c has a radial thickness larger than the radial thicknesses of the second tubular segments 53a and 53b. That is, the second tubular segment 53c having a larger thickness has the grooves 53f extending in the direction of the rotational axis AX2. The grooves 53f are each defined by a curved wall having an arc shape in the XZ plane, as in Embodiment 1.

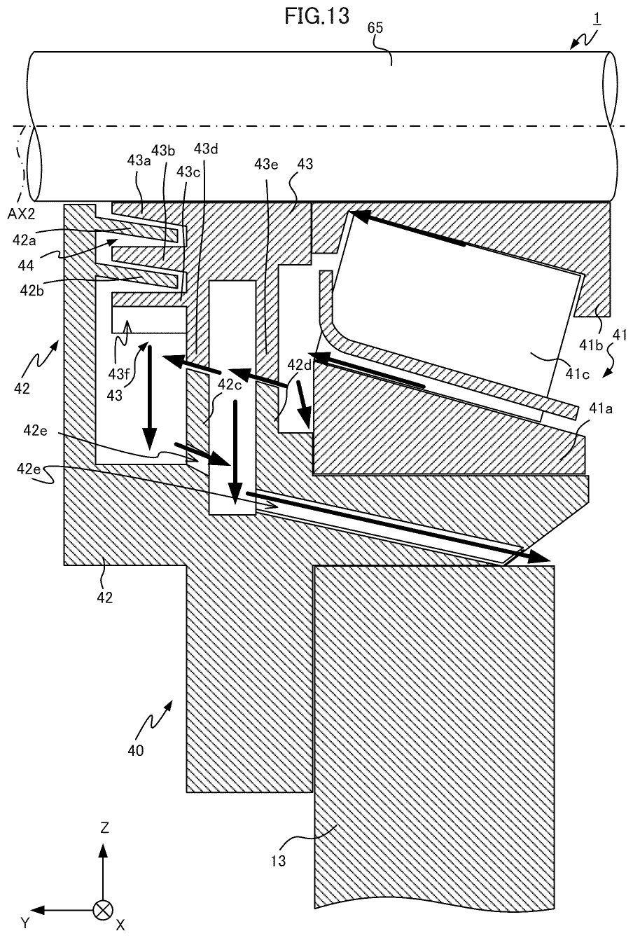

FIG. 13 illustrates an example of flows of the lubricant 15 in the gear mechanism 1 having the above-described configuration, with solid-line arrows. FIG. 13 illustrates only some of the flows of the lubricant 15, in order to simplify the figure. The lubricant 15, which flows from the driving gear 11 in the positive Y-axis direction and adheres to the first bearing 41, travels through the gaps between the rolling elements 41c and the inner race 41a or the gaps between the rolling elements 41c and the outer race 41b in the positive Y-axis direction.

The sufficiently narrow gaps between the first annular segments 42c and 42d and the second annular segments 43d and 43e can reduce the amount of the lubricant 15 that enters the first bearing retainer 42 through the first bearing 41.

In detail, a part of the lubricant 15 that flows from the first bearing 41 in the positive Y-axis direction fails to pass through the gap between the first annular segment 42d and the second annular segment 43e, travels radially outward along the first annular segment 42d, and returns to the first bearing 41. The other part of the lubricant 15 that flows from the first bearing 41 in the positive Y-axis direction passes through the gap between the first annular segment 42d and the second annular segment 43e.

A part of the lubricant 15 that passes through the gap between the first annular segment 42d and the second annular segment 43e fails to pass through the gap between the first annular segment 42c and the second annular segment 43d, travels radially outward along the first annular segment 42c, and returns through the channel 42e to the vertically lower portion of the gear housing 13. The other part of the lubricant 15 that passes through the gap between the first annular segment 42d and the second annular segment 43e passes through the gap between the first annular segment 42c and the second annular segment 43d.

The labyrinth structure 44 suppresses radial inward flow of the lubricant 15 passing through the gap between the first annular segment 42c and the second annular segment 43d. Thereby, suppressing the flow of the lubricant 15 exiting the gear housing 13 through the gap between the first bearing retainer 42 and the axle 65.

The grooves 43f allow the second tubular segment 43c of the oil thrower 43, which rotates integrally with the axle 65, to serve as a fan, and generate radially outward airflows. The airflows facilitate the lubricant 15 that passes through the gap between the first annular segment 42c and the second annular segment 43d to travel radially outward. The lubricant 15 traveling radially outward returns through the channel 42e to the vertically lower portion of the gear housing 13.

Even when the rotation of the axle 65 induces a negative pressure around the axle 65 outside the gear housing 13, the second tubular segment 43c having the grooves 43f also serves as a fan and generates radial airflows. The airflows cause the lubricant 15 to travel in the radial direction, and suppress leakage of the lubricant 15 from the gear housing 13.

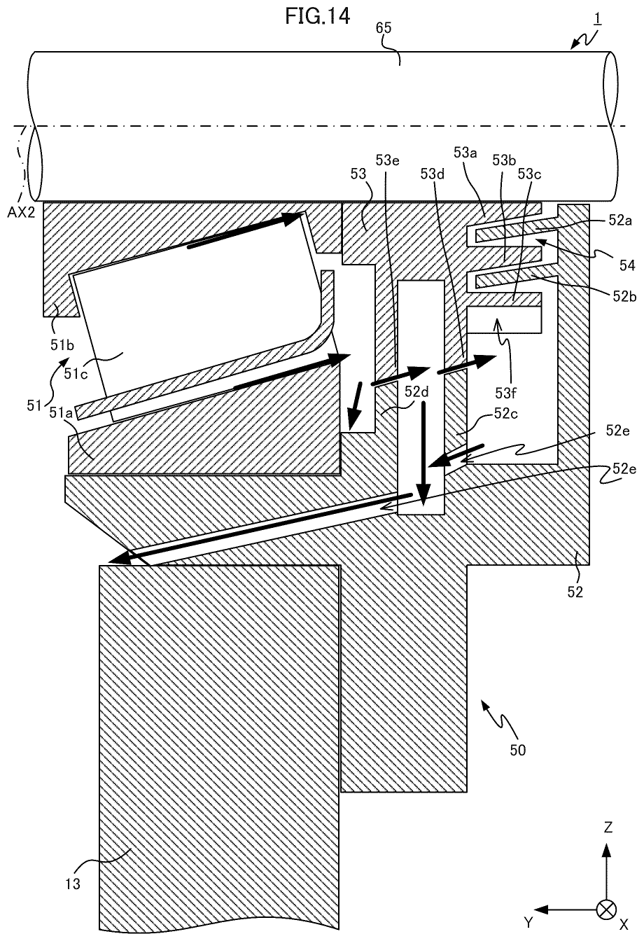

FIG. 14 illustrates another example of flows of the lubricant 15 in the gear mechanism 1, with solid-line arrows. FIG. 14 illustrates only some of the flows of the lubricant 15, in order to simplify the figure. The lubricant 15, which flows from the driving gear 11 in the negative Y-axis direction and adheres to the first bearing 51, travels through the gaps between the rolling elements 51c and the inner race 51a or the gaps between the rolling elements 51c and the outer race 51b in the negative Y-axis direction.

The sufficiently narrow gaps between the first annular segments 52c and 52d and the second annular segments 53d and 53e can reduce the amount of the lubricant 15 that enters the first bearing retainer 52 through the first bearing 51.

In detail, a part of the lubricant 15 that flows from the first bearing 51 in the negative Y-axis direction fails to pass through the gap between the first annular segment 52d and the second annular segment 53e, travels radially outward along the first annular segment 52d, and returns to the first bearing 51. The other part of the lubricant 15 that flows from the first bearing 51 in the negative Y-axis direction passes through the gap between the first annular segment 52d and the second annular segment 53e.

A part of the lubricant 15 that passes through the gap between the first annular segment 52d and the second annular segment 53e fails to pass through the gap between the first annular segment 52c and the second annular segment 53d, travels radially outward along the first annular segment 52c, and returns through the channel 52e to the vertically lower portion of the gear housing 13. The other part of the lubricant 15 that passes through the gap between the first annular segment 52d and the second annular segment 53e passes through the gap between the first annular segment 52c and the second annular segment 53d.

The labyrinth structure 54 suppresses radial inward flow of the lubricant 15 passing through the gap between the first annular segment 52c and the second annular segment 53d. Thereby, suppressing the flow of the lubricant 15 exiting the gear housing 13 through the gap between the first bearing retainer 52 and the axle 65.

The grooves 53f allow the second tubular segment 53c of the oil thrower 53, which rotates integrally with the axle 65, to serve as a fan, and generate radially outward airflows. The airflows facilitate the lubricant 15 that passes through the gap between the first annular segment 52c and the second annular segment 53d to travel radially outward. The lubricant 15 traveling radially outward returns through the channel 52e to the vertically lower portion of the gear housing 13.

Even when the rotation of the axle 65 induces a negative pressure around the axle 65 outside the gear housing 13, the second tubular segment 53c having the grooves 53f also serves as a fan and generates radial airflows. The airflows cause the lubricant 15 to travel in the radial direction, and suppresses leakage of the lubricant 15 from the gear housing 13.

As described above, the bearing unit 40 according to Embodiment 2 includes the second tubular segment 43c having the grooves 43f circumferentially arranged on the outer periphery, and the oil thrower 43 that defines the labyrinth structure 44 against the first bearing retainer 42. The bearing unit 50 includes the second tubular segment 53c having the grooves 53f circumferentially arranged on the outer periphery, and the oil thrower 53 that defines the labyrinth structure 54 against the first bearing retainer 52. The bearing units 40 and 50, when installed in the gear housing 13 of the gear mechanism 1, can thus suppress leakage of the lubricant 15 enclosed in the gear housing 13.

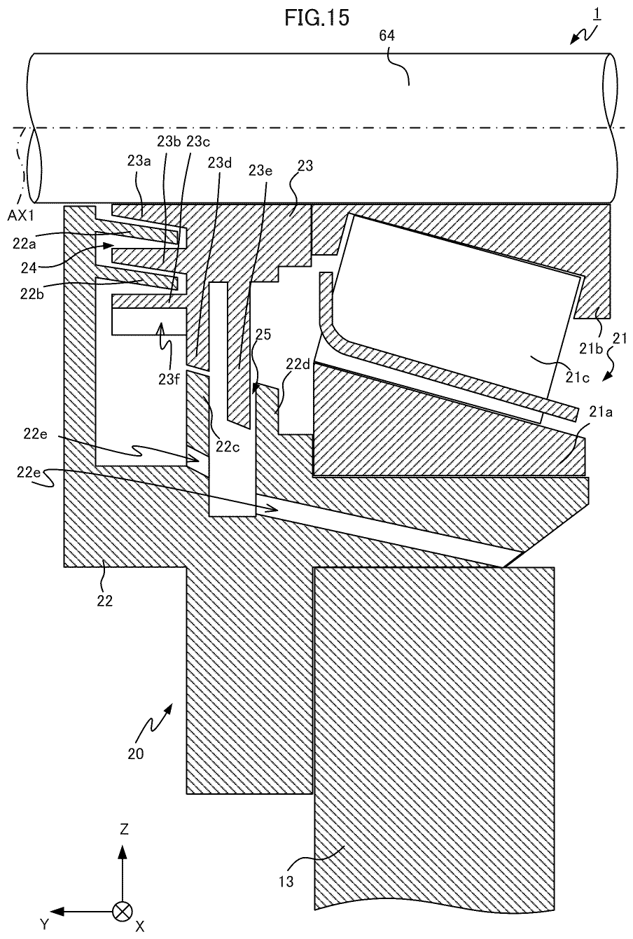

The above-described embodiments are not to be construed as limiting the scope of the present disclosure. The bearing units 20, 40, and 50 may have any structure other than that in the above-described examples, provided that the structure can suppress leakage of the lubricant 15 to the outside of the gear housing 13. For example, as illustrated in FIG. 15, a part of the first annular segment 22d of the first bearing retainer 22 of the bearing unit 20 included in the gear mechanism 1 and a part of the second annular segment 23e of the oil thrower 23 may be opposed to each other with a space therebetween in the direction of the rotational axis AX1 of the driving shaft 64. This arrangement defines a labyrinth structure 25, and suppresses the flow of the lubricant 15 in the positive Y-axis direction. Also, a part of the first annular segment 22c of the first bearing retainer 22 and a part of the second annular segment 23d of the oil thrower 23 may be opposed to each other with a space therebetween in the direction of the rotational axis AX1, and thus define a labyrinth structure.

Also, a part of the first annular segment 42d of the first bearing retainer 42 and a part of the second annular segment 43e of the oil thrower 43 may be opposed to each other with a space therebetween in the direction of the rotational axis AX2, and thus define a labyrinth structure. A part of the first annular segment 42c of the first bearing retainer 42 and a part of the second annular segment 43d of the oil thrower 43 may be opposed to each other with a space therebetween in the direction of the rotational axis AX2, and thus define a labyrinth structure.

Also, a part of the first annular segment 52d of the first bearing retainer 52 and a part of the second annular segment 53e of the oil thrower 53 may be opposed to each other with a space therebetween in the direction of the rotational axis AX2, and thus define a labyrinth structure. A part of the first annular segment 52c of the first bearing retainer 52 and a part of the second annular segment 53d of the oil thrower 53 may be opposed to each other with a space therebetween in the direction of the rotational axis AX2, and thus define a labyrinth structure.

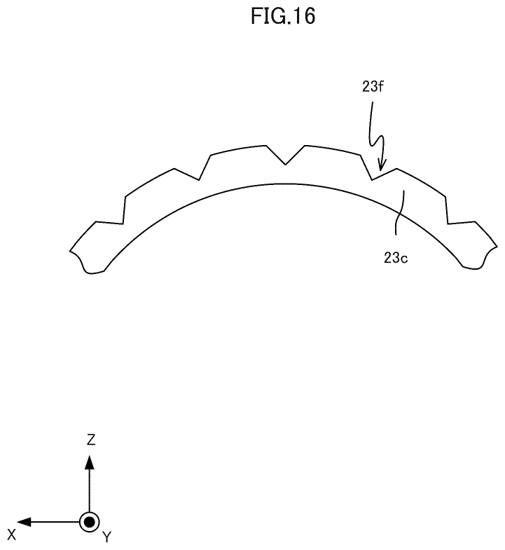

The grooves 23f, 43f, and 53f on the second tubular segments 23c, 43c, and 53c of the oil throwers 23, 43, and 53 may have shapes other than that in the above-described examples. For example, as illustrated in FIG. 16, the grooves 23f of the second tubular segment 23c of the oil thrower 23 may each be defined by flat walls. The same holds true for the grooves 43f and 53f. For another example, the grooves 23f, 43f, and 53f may each be defined by a flat bottom and side walls.

The maximum depth or radial length of the grooves 23f, 43f, and 53f illustrated in the above examples may be arbitrarily modified. The number of the grooves 23f, 43f, and 53f and the interval therebetween illustrated in the above examples may be arbitrarily modified. The grooves 23f may extend not in the direction of the rotational axis AX1 but in a direction intersecting the rotational axis AX1. Also, the grooves 43f and 53f may extend not in the direction of the rotational axis AX2 but in a direction intersecting the rotational axis AX2.

Although the first bearing 21 and the second bearing 31 are made of tapered roller bearings in the above-described embodiments, the first bearing 21 and the second bearing 31 may have any structure that can support the driving shaft 64 such that the driving shaft 64 is rotatable. For example, the first bearing 21 and the second bearing 31 may each be made of a ball bearing or a cylindrical roller bearing. Also, the first bearings 41 and 51 may have any structure that can support the axle 65 such that the axle 65 is rotatable. For example, the first bearings 41 and 51 may each be made of a ball bearing or a cylindrical roller bearing.

The number and shape of the first tubular segments 22a and 22b illustrated in the above examples may be arbitrarily modified. For example, the first bearing retainer 22 of the gear mechanism 1 may include the first tubular segment 22a alone, or may include the first tubular segments 22a and 22b and another first tubular segment. The first tubular segments 22a and 22b may each have a hollow cylindrical shape having a constant inner diameter.

The number and shape of the second tubular segments 23a, 23b, and 23c illustrated in the above examples may be arbitrarily modified. The oil thrower 23 of the gear mechanism 1 may include the second tubular segments 23a and 23c alone, or may include the second tubular segments 23a, 23b, and 23c and another second tubular segment.

The second tubular segments 23a, 23b, and 23c may have the same length or mutually different lengths in the direction of the rotational axis AX1 of the driving shaft 64. The second tubular segments 23a and 23b may have grooves 23f, like the second tubular segment 23c. The second tubular segments 23a, 23b, and 23c may have the same radial thickness.

The number and shape of the first tubular segments 42a and 42b illustrated in the above examples may be arbitrarily modified. For example, the first bearing retainer 42 of the gear mechanism 1 may include the first tubular segment 42a alone, or may include the first tubular segments 42a and 42b and another first tubular segment. The first tubular segments 42a and 42b may each have a hollow cylindrical shape having a constant inner diameter.

The number and shape of the second tubular segments 43a, 43b, and 43c illustrated in the above examples may be arbitrarily modified. The oil thrower 43 of the gear mechanism 1 may include the second tubular segments 43a and 43c alone, or may include the second tubular segments 43a, 43b, and 43c and another second tubular segment.

The second tubular segments 43a, 43b, and 43c may have the same length or mutually different lengths in the direction of the rotational axis AX2 of the axle 65. The second tubular segments 43a and 43b may have grooves 43f, like the second tubular segment 43c. The second tubular segments 43a, 43b, and 43c may have the same radial thickness.

The number and shape of the first tubular segments 52a and 52b illustrated in the above examples may be arbitrarily modified. For example, the first bearing retainer 52 of the gear mechanism 1 may include the first tubular segment 52a alone, or may include the first tubular segments 52a and 52b and another first tubular segment. The first tubular segments 52a and 52b may each have a hollow cylindrical shape having a constant inner diameter.

The number and shape of the second tubular segments 53a, 53b, and 53c illustrated in the above examples may be arbitrarily modified. The oil thrower 53 of the gear mechanism 1 may include the second tubular segments 53a and 53c alone, or may include the second tubular segments 53a, 53b, and 53c and another second tubular segment.

The second tubular segments 53a, 53b, and 53c may have the same length or mutually different lengths in the direction of the rotational axis AX2 of the axle 65. The second tubular segments 53a and 53b may have grooves 53f, like the second tubular segment 53c. The second tubular segments 53a, 53b, and 53c may have the same radial thickness.

The gear mechanism 1 may be applied to, not only a railway vehicle, but also any moving body, such as automobile or bus, and may also be installed in an industrial machine.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

1 Gear mechanism
11 Driving gear
12 Driven gear
13 Gear housing
13a Upper opening
13b, 13c First opening
13d, 13e Second opening
14 Lid
15 Lubricant
20, 40, 50 Bearing unit
21, 41, 51 First bearing
21a, 31a, 41a, 51a Inner race
21b, 31b, 41b, 51b Outer race
21c, 31c, 41c, 51c Rolling element
22, 42, 52 First bearing retainer
22a, 22b, 42a, 42b, 52a, 52b First tubular segment
22c, 22d, 42c, 42d, 52c, 52d First annular segment
22e, 42e, 52e Channel
23, 43, 53 Oil thrower
23a, 23b, 23c, 43a, 43b, 43c, 53a, 53b, 53c Second tubular segment
23d, 23e, 43d, 43e, 53d, 53e Second annular segment
23f, 43f, 53f Groove
24, 25, 44, 54 Labyrinth structure
31 Second bearing
32 Second bearing retainer
60 Bogie
61 Motor
62 Output shaft
63 Joint
64 Driving shaft
65 Axle
66 Wheel
67 Ground ring
AX1, AX2 Rotational axis

1. A bearing unit, comprising;
a first bearing to support a shaft such that the shaft is rotatable;
a first bearing retainer having a through hole that receives the shaft inserted therethrough and including first tubular segments located adjacent to each other in a radial direction, the first bearing retainer being configured to retain the first bearing while the shaft is disposed through the through hole; and
an oil thrower attached to the shaft at a position between the first bearing retainer and the first bearing, the oil thrower extending toward the first bearing retainer and defining a labyrinth structure against the first bearing retainer, the oil thrower having grooves circumferentially arranged on an outer periphery, wherein each of the first tubular segments extends in a direction of a rotational axis of the shaft, has a tubular shape of which an inner diameter increases toward the oil thrower, and defines a labyrinth structure against the oil thrower.

2. (canceled)

3. (canceled)

4. The bearing unit according to claim 1, wherein the first bearing retainer further includes one or more first annular segments each having an annular shape, the one or more first annular segments extending toward the oil thrower in the radial direction.

5. The bearing unit according to claim 4, wherein the one or more first annular segments define a labyrinth structure against the oil thrower.

6. The bearing unit according to claim 1, wherein the oil thrower includes one or more second tubular segments each having a hollow tubular shape extending toward the first bearing retainer in the direction of the rotational axis of the shaft, the one or more second tubular segments having ends adjacent to the first bearing retainer that define a labyrinth structure against the first bearing retainer.

7. The bearing unit according to claim 6, wherein the oil thrower includes second tubular segments located adjacent to each other in the radial direction.

8. The bearing unit according to claim 7, wherein the grooves are provided to an outer periphery of a second tubular segment having a largest outer diameter among the second tubular segments.

9. The bearing unit according to claim 7, wherein a second tubular segment having a largest outer diameter among the second tubular segments has a radial thickness larger than a radial thickness of another of the second tubular segments.

10. The bearing unit according to claim 6, wherein at least any of the second tubular segments has a tapered shape of which a radial thickness decreases toward the first bearing retainer.

11. The bearing unit according to claim 1, wherein the grooves extend in the direction of the rotational axis of the shaft.

12. The bearing unit according to claim 1, wherein the oil thrower further includes one or more second annular segments each having an annular shape, the one or more second annular segments extending toward the first bearing retainer in the radial direction.

13. The bearing unit according to claim 12, wherein the one or more second annular segments define a labyrinth structure against the first bearing retainer.

14. A gear mechanism, comprising:
a driving gear attached to a driving shaft to rotate integrally with the driving shaft;
the bearing unit according to claim 1;
a second bearing to hold the driving gear against the bearing unit, and support one end of the driving shaft such that the driving shaft is rotatable;
a second bearing retainer to retain the second bearing;
a gear housing having a first opening that receives the driving shaft inserted therethrough, the gear housing being configured to accommodate the first bearing and the oil thrower included in the bearing unit, the driving gear, and the second bearing; and
a lubricant enclosed in the gear housing, wherein
the first bearing included in the bearing unit supports the driving shaft such that the driving shaft is rotatable, and
the first bearing retainer included in the bearing unit is attached to the gear housing such that the first bearing retainer closes the first opening.

15. A gear mechanism according to claim 14, further comprising:
a driving gear attached to a driving shaft to rotate integrally with the driving shaft;
the bearing unit according to claim 1;
a second bearing to hold the driving gear against the bearing unit, and support one end of the driving shaft such that the driving shaft is rotatable;
a second bearing retainer to retain the second bearing;
a gear housing having a first opening that receives the driving shaft inserted therethrough, the gear housing being configured to accommodate the first bearing and the oil thrower included in the bearing unit, the driving gear, and the second bearing;
a lubricant enclosed in the gear housing;
a driven gear attached to a driven shaft such that the driven gear meshes with the driving gear; and
a pair of driven-shaft bearing units each including the bearing unit according to claim 1, wherein
the first bearing included in the bearing unit supports the driving shaft such that the driving shaft is rotatable,
the first bearing retainer included in the bearing unit is attached to the gear housing such that the first bearing retainer closes the first opening,
the first bearing included in each of the pair of driven-shaft bearing units supports the driven shaft such that the driven shaft is rotatable,
the gear housing has a pair of second openings that receive the driven shaft inserted therethrough,
the gear housing further accommodates the driven gear, and
the first bearing retainer included in each of the pair of driven-shaft bearing units is attached to the gear housing such that the first bearing retainer closes a corresponding one of the pair of second openings.
